(19) United States
(12) Patent Application Publication
(10) Pub. No.: US 2014/0174348 A1
(43) Pub. Date: Jun. 26, 2014

(54) GLUE COATING DEVICE

(71) Applicants: HON HAI PRECISION INDUSTRY CO., LTD., New Taipei (CN); HONG FU JIN PRECISION INDUSTRY (ShenZhen) CO., LTD, Shenzhen (CN)

(72) Inventors: TENG-TSUNG HUANG, New Taipei (TW); YONG-BING HU, Shenzhen (CN); GONG-SHUI CHENG, Shenzhen (CN)

(73) Assignees: HON HAI PRECISION INDUSTRY CO., LTD., New Taipei (CN); HONG FU JIN PRECISION INDUSTRY (ShenZhen) CO., LTD, Shenzhen (CN)

(21) Appl. No.: 13/955,269

(22) Filed: Jul. 31, 2013

(30) Foreign Application Priority Data
Dec. 26, 2012 (CN) 2012105715340

(51) Int. Cl. B05C 21/00

(52) U.S. Cl. CPC B05C 21/00
USPC 118/669

(57) ABSTRACT

A glue coating device for coating glue on a workpiece includes a table, a first driving mechanism assembled on the table, a second driving mechanism slidably assembled to the first driving mechanism, a rotating mechanism assembled to the second driving mechanism, and a dispensing assembly assembled to the rotating mechanism. The second driving mechanism is driven by the first driving mechanism to slide along a first direction perpendicular to the table. The rotating mechanism is driven by the second driving mechanism to slide along a second direction perpendicular to the table. The dispensing assembly is driven by the rotating mechanism to rotate.

### CROSS-REFERENCE TO RELATED APPLICATIONS

This application is related to co-pending U.S. Patent Application (U.S. Ser. No. 13/912614, Pending), entitled “ADHESIVE DISPENSER AND ADHESIVE NOZZLE REGULATING METHOD”, invented by Huang et al. Such application has the same assignee as the present application. The above-identified application is incorporated herein by reference.

### BACKGROUND

1. Technical Field

The present disclosure generally relates to glue coating devices.

2. Description of related art

Sometimes, two elements need to be assembled together by adhesive or glue during assembly of electronic devices. A typical glue dispenser for coating glue on the elements can move along the x, y, and z coordinate axes in a Cartesian coordinate system to adjust coating positions. Such a glue dispenser is able to coat adhesive or glue on plane surfaces of the elements. However, surfaces of these elements are not always planar, and it is difficult to coat adhesive or glue on non-planar surfaces (such as arcuate side surfaces) of the elements using such a glue dispenser.

Therefore, there is room for improvement within the art.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is an isometric view of a glue coating device in accordance with an exemplary embodiment.

FIG. 2 is an exploded view of some components of the glue coating device of FIG. 1.

FIG. 3 is an enlarged, exploded view of a positioning unit of the glue coating device of FIG. 1.

FIG. 4 is an enlarged, exploded view of a driving assembly of the glue coating device of FIG. 1 viewed from a first angle.

FIG. 5 is an enlarged, exploded view of the driving assembly of the glue coating device of FIG. 1 viewed from a second angle.

FIG. 6 is an enlarged, exploded view of a dispensing assembly of the glue coating device of FIG. 1.

FIG. 7 is an enlarged, partial view of the dispensing assembly of FIG. 6.

### DETAILED DESCRIPTION

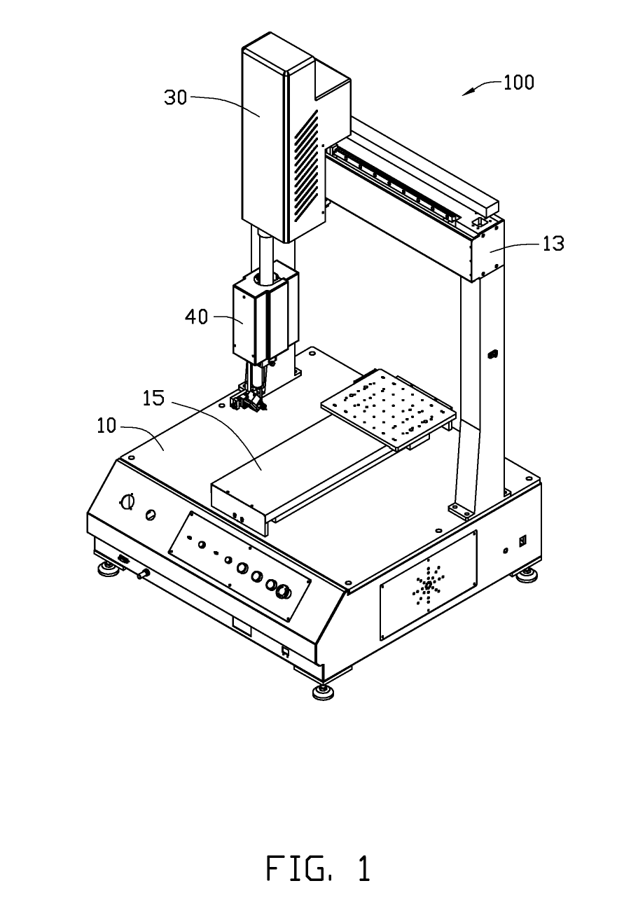

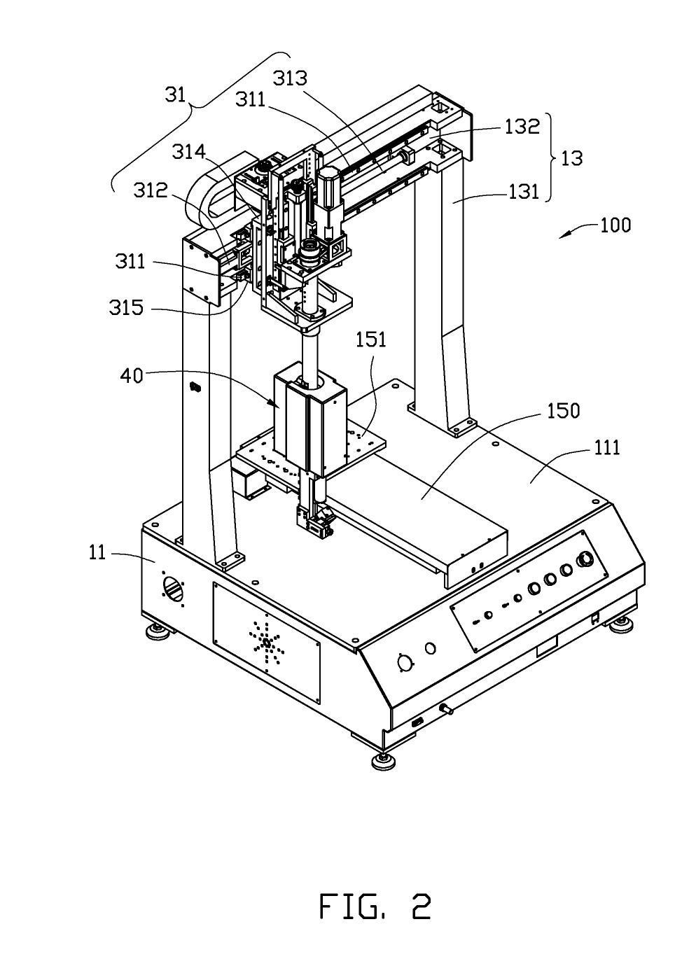

FIGS. 1 and 2 show an exemplary embodiment of a glue coating device 100, which includes a table 10, a driving assembly 30, and a dispensing assembly 40. The driving assembly 30 is fixed to the table 10. The dispensing assembly 40 is assembled to and driven by the driving assembly 30 to move to a correct position relative to a workpiece (not shown) positioned on the table 10. The dispensing assembly 40 dispenses glue/adhesive to the workpiece.

The table 10 includes a case 11 having a controller (not shown) assembled therein, a supporting frame 13, and a positioning unit 15. The case 11 includes a top board 111. The supporting frame 13 includes two pillars 131 attached substantially perpendicularly to the top board 111, and an arm 132 substantially parallel to the top board 111. Two ends of the arm 132 are attached to the two pillars 131, respectively. The supporting frame 13 is configured for supporting the driving assembly 30 and the dispensing assembly 40.

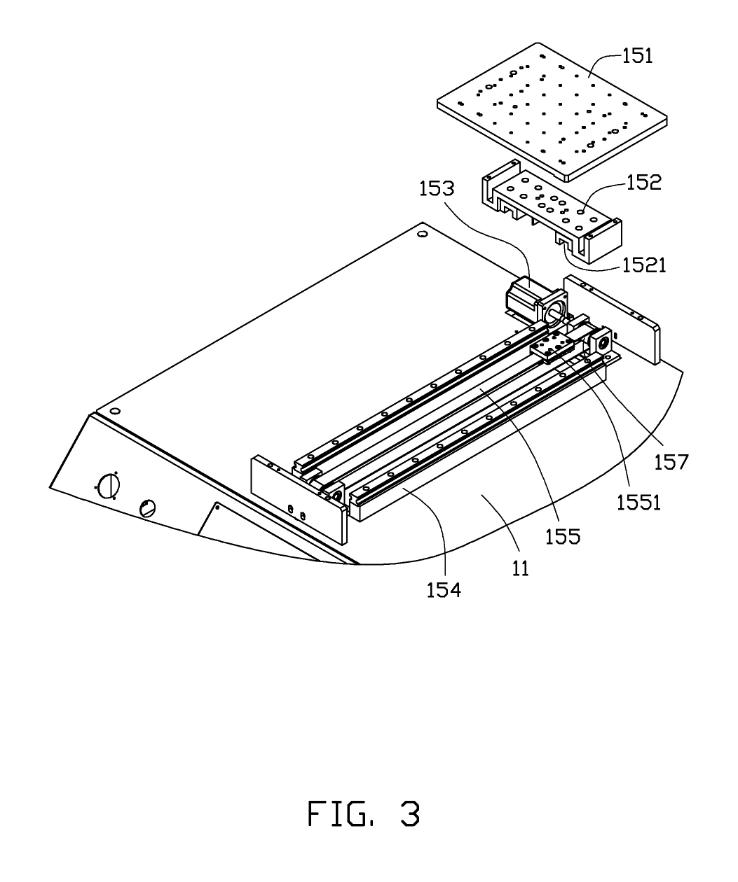

The positioning unit 15 is configured for positioning workpieces. Referring to FIGS. 2 and 3, the positioning unit 15 includes a cover board 150, a positioning board 151, a sliding block 152, a driving element 153, two guiding rails 154, and a conveyor belt 155. The two guiding rails 154 are attached on the top board 111 and are located between the two pillars 131. The two guiding rails 154 are spaced from and parallel to each other. The driving element 153 is positioned on the top board 111 and is adjacent to an end of the two guiding rails 154. The driving element 153 may be a motor, for example. The conveyor belt 155 is located between and is substantially parallel to the two guiding rails 154. The conveyor belt 155 rotates about two rollers 157, one of which is rotated by the driving element 153. The conveyor belt 155 has a connecting block 1551 attached thereon. The sliding block 152 defines two sliding grooves 1521 in a first surface. The sliding block 152 is mounted to the connecting block 1551 with the connecting block 1551 located between the two sliding grooves 1521. The two sliding grooves 1521 slidably receive the two guiding rails 154. The positioning board 151 is attached to a second surface of the sliding block 152 opposite to the first surface. The positioning board 151 is configured for supporting workpieces, which may be received in a fixing tool. The cover board 150 covers and protects the positioning unit 15 when the glue coating device is not operating.

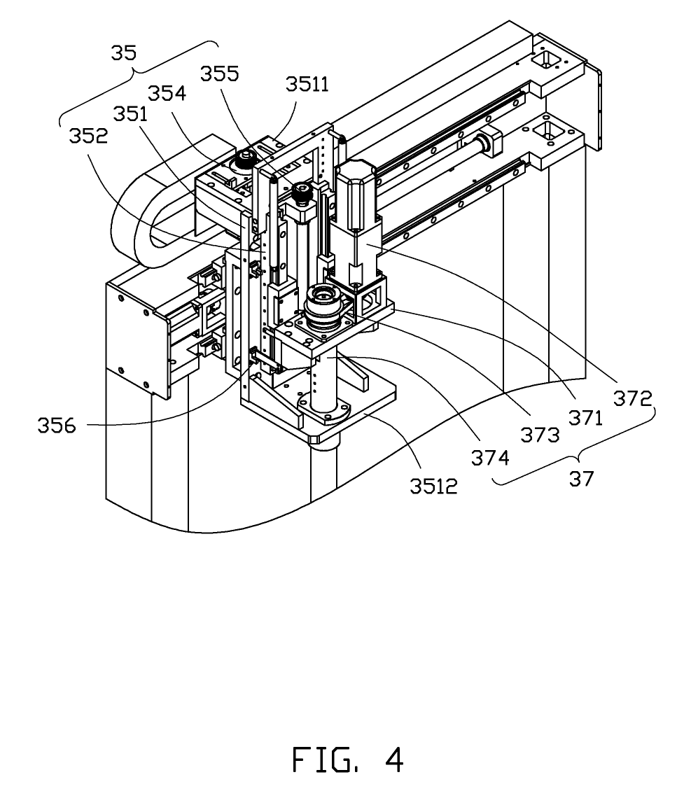

Referring to FIGS. 2 and 4, the driving assembly 30 includes a first driving mechanism 31, a second driving mechanism 35, and a rotating mechanism 37.

The first driving mechanism 31 includes two first sliding rails 311, a first motor 312, a first ball screw 313, and a first sliding board 314. The two first sliding rails 311 are mounted on the arm 132 and are substantially parallel to the arm 132. The first motor 312 is attached to the arm 132 and is adjacent to an end of the two first sliding rails 311. The first ball screw 313 is located between the two first sliding rails 311 and is connected to the first motor 312. The first ball screw 313 is a mechanical linear actuator that translates rotational motion into linear motion. The first ball screw 313 includes a threaded shaft providing a helical raceway for ball bearings, and acts as a precision screw. The first ball screw 313 is driven by the first motor 312 to rotate. The first sliding board 314 defines two first sliding grooves 315 in a surface. The first sliding board 314 is slidably attached to the first ball screw 313 with the two first sliding grooves 315 slidably receiving the two first sliding rails 311.

The second driving mechanism 35 includes a mounting board 351, two second sliding rails 352, a second motor 354, and a second ball screw 355. The mounting board 351 is substantially rectangular and is attached to the first sliding board 314. A first extending board 3511 extends substantially perpendicularly from an upper end of the mounting board 351, and a second extending board 3512 extends substantially perpendicularly from a lower end of the mounting board 351. The first extending board 3511 is located above the arm 132. The second motor 354 is mounted to the first extending board 3511. The two second sliding rails 352 and the second ball screw 355 are mounted to a surface of the mounting board 351 away from the first sliding board 314. The second ball screw 355 is located between the two second sliding rails 352 and is driven by the second motor 354.

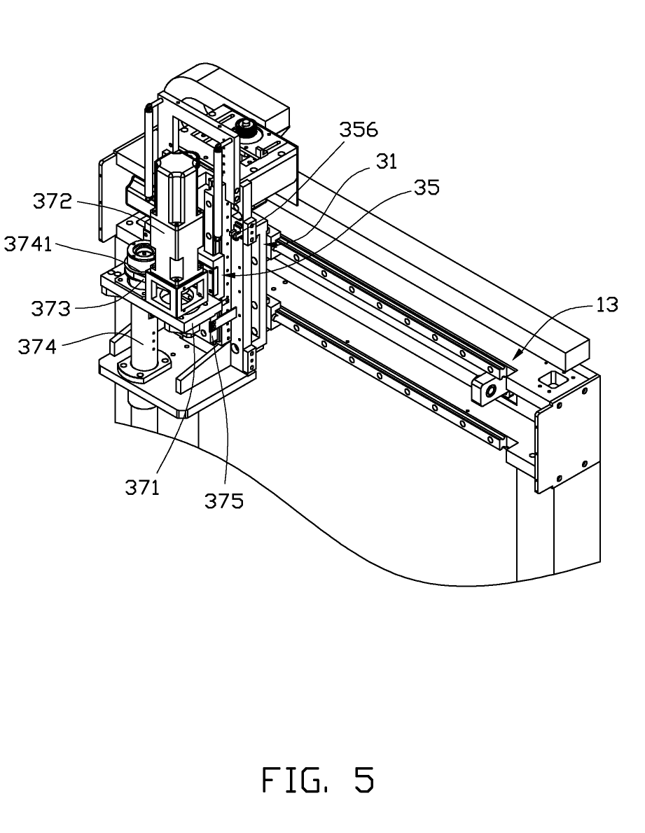

Referring to FIGS. 4 and 5, the rotating mechanism 37 includes a first fixing board 371, a driver 372, a first transmission belt 373, a shaft 374, and a second sliding board 375. The first fixing board 371 is substantially rectangular and is attached to the second sliding board 375. The driver 372 is mounted on the first fixing board 371. The driver 372 may be a motor, for example. The shaft 374 extends through the first fixing board 371 and the second extending board 3512. The shaft 374 defines an annular recess 3741 in an exterior circumferential wall at an upper end. The shaft 374 is connected to the driver 372 through the first transmission belt 373, which is coiled in the annular recess 3741, to allow the driver 372 to rotate the shaft 374. The driver 372 drives the transmission belt 373 to rotate about the shaft 374, thereby driving the shaft 374 to rotate. The second sliding board 375 is slidably attached to the second ball screw 355, thereby bringing the shaft 374 and the driver 372 to slide relative to the mounting board 351.

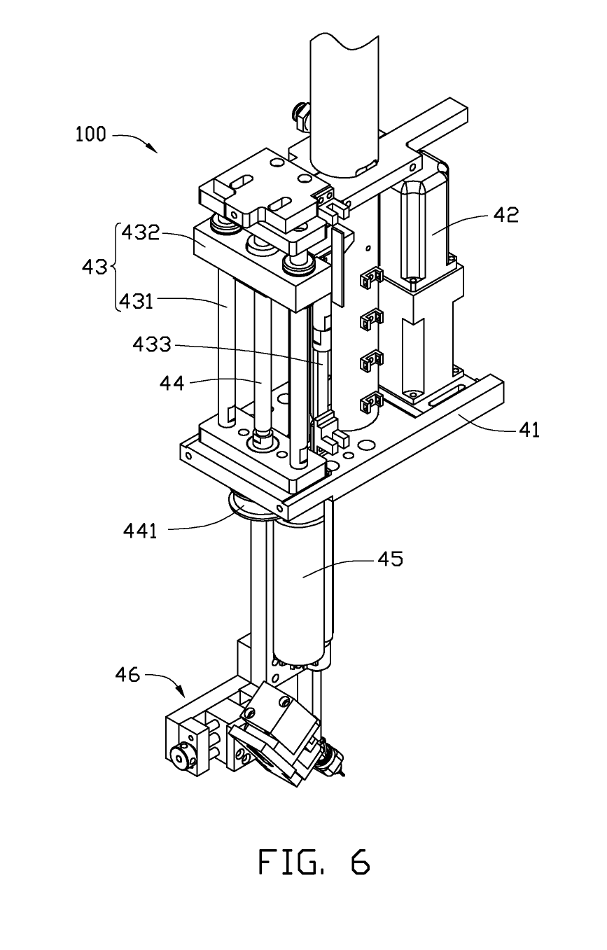

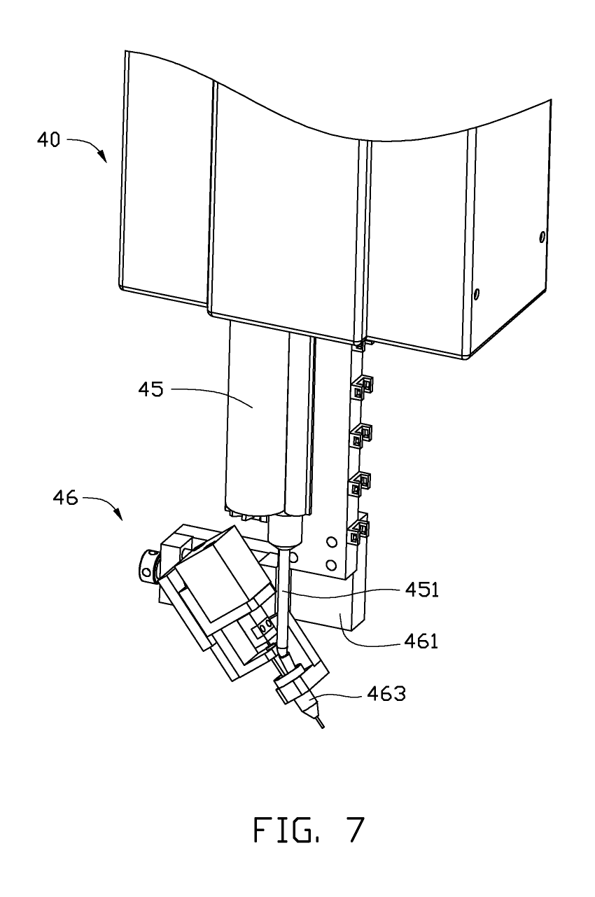

Referring to FIGS. 6 and 7, the dispensing assembly 40 includes a supporting board 41, a third motor 42, a sliding frame 43, a third ball screw 44, a container 45, and a dispensing unit 46. The supporting board 41 is attached to a lower end of the shaft 374. The third motor 42 and the sliding frame 43 are attached to a surface of the supporting board 41 facing the arm 132 and are located at two sides of the shaft 374. The container 45 is attached to another surface of the supporting board 41 opposite to the arm 132. The container 45 is configured for accommodating adhesive/glue and has a duct 451, which is substantially cylindrical for dispensing the adhesive/glue. The sliding frame 43 includes two guiding poles 431, a pushing board 432, and a pushing pole 433. The pushing pole 433 is attached to the pushing board 432 and extends through the supporting board 41 to be inserted into the container 45 for pushing adhesive/glue out of the container 45. The third ball screw 44 is positioned between the two guiding poles 431 and is substantially parallel to the two guiding poles 431. The third ball screw 44 extends through the supporting board 41 to be connected to the third motor 42 through a second transmission belt 441. The pushing board 432 is attached to the two guiding poles 431 and the third ball screw 44.

Referring to FIG. 7, the dispensing unit 46 includes a second fixing board 461 and a dispensing needle 463. The second fixing board 461 is connected to the supporting board 41. The dispensing needle 463 is connected to the duct 451 and extends at an inclined angle relative to the duct 451.

In use, referring to FIGS. 2-7, workpieces are positioned on the positioning board 151. The driving element 153 is turned on to drive the positioning board 151 to slide to a desired position. At the same time, the first motor 312 of the first driving mechanism 31 drives the first ball screw 313 to rotate, thereby driving the first sliding board 314 to slide along the first sliding rails 311. That is, the first sliding board 314 slides relative to the case 11 along a first direction substantially perpendicular to the sliding direction of the positioning board 151, bringing the second driving mechanism 35 and the rotating mechanism 37 to slide along the arm 132 until the second driving mechanism 35 and the rotating mechanism 37 are located above the positioning board 151. The second driving mechanism 35 is then turned on. The second motor 354 drives the second ball screw 355 to rotate, thereby driving the first fixing board 371 to slide relative to the mounting board 351. That is, the second driving mechanism 35 drives the first fixing board 371 to slide towards the positioning board 151 along a second direction substantially perpendicular to the first direction, enabling the dispensing needle 463 to be aligned with a region of a workpiece that needs to be glued. At this time, the dispensing assembly 40 is turned on. The third motor 42 rotates the third ball screw 44 to force the pushing board 432 to slide along the guiding poles 431, thereby forcing the pushing pole 433 to slide toward the container 45 to push adhesive/glue out of the dispensing needle 463 through the duct 451. When a side surface or an arcuate surface of the workpiece needs to be coated, the rotating mechanism 37 is turned on. The driver 372 rotates the shaft 374. The shaft 374 rotates the dispensing assembly 40, thereby rotating the dispensing needle 463 to be aligned with a side surface or an arcuate surface of the workpiece.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A glue coating device for coating glue on a workpiece, the glue coating device comprising:
a table;
a first driving mechanism assembled on the table;
a second driving mechanism slidably assembled to the first driving mechanism, the second driving mechanism driven by the first driving mechanism to be capable of horizontally sliding relative to the table;
a rotating mechanism assembled to the second driving mechanism and driven by the second driving mechanism to be capable of vertically sliding relative to the table; and
a dispensing assembly assembled to the rotating mechanism and driven by the rotating mechanism to rotate.

2. The glue coating device as claimed in claim 1, wherein the rotating mechanism comprises a first fixing board slidably assembled to the second driving mechanism, a driver assembled to the first fixing board, and a shaft extending through the first fixing board and capable of sliding relative to the first fixing board; the second driving mechanism drives the first fixing board bring with the driver and the shaft to vertically move relative to the table; the shaft is connected to the driver through a first transmission belt to allow the driver to rotate the shaft.

3. The glue coating device as claimed in claim 2, wherein the table comprises a case and a support frame protruding from the case; the support frame comprises two pillars attached to the case and an arm parallel to the case and connected to the two pillars; the first driving mechanism comprises two first sliding rails mounted on the arm, a first motor, a first ball screw located between the two first sliding rails, and a first sliding board; the first ball screw is connected to the first motor and driven by the first motor to rotate; the first sliding board defines two first sliding grooves; and the first sliding board is movably attached to the first ball screw with the two first sliding grooves slidably receiving the two first sliding rails.

4. The glue coating device as claimed in claim 3, wherein the second driving mechanism comprises a mounting board, two second sliding rails mounted on the mounting board, a second ball screw located between the two second sliding rails, and a second motor connected to the second ball screw to drive the second ball screw to rotate; the mounting board is mounted to the first sliding board and capable of sliding with the first sliding board along the arm.

5. The glue coating device as claimed in claim 4, wherein the rotating mechanism further comprises a second sliding board; the first fixing board is attached to the second sliding board; the second sliding board is movably attached to the second ball screw.

6. The glue coating device as claimed in claim 5, wherein the dispensing assembly comprises a support board attached to an end of the shaft, a sliding frame, and a container; the third motor and the sliding frame are mounted on a first surface of support board facing the arm; the container is attached to a second surface of the support board opposite to the first surface; the sliding frame comprises a pushing pole extending through the support board and inserted into the container.

7. The glue coating device as claimed in claim 6, wherein the dispensing assembly further comprises a third ball screw and a third motor; the sliding frame further comprises a pushing board and two guiding poles; the third ball screw is positioned between the two guiding poles and extends through the support board to be connected to the third motor through a second transmission belt; the pushing board is attached to the two guiding poles and the third ball screw; the pushing pole is attached to the pushing board; the third motor rotates the third ball screw to force the pushing board to slide along the guiding poles, thereby forcing the pushing pole to slide toward the container.

8. The glue coating device as claimed in claim 7, wherein the container has a duct;
the dispensing assembly further comprises a dispensing needle; the dispensing needle is connected to the duct and extends at an inclined angle to the duct.

9. The glue coating device as claimed in claim 3, wherein the table further comprises a positioning unit; the positioning unit comprises a positioning board, a sliding block attached to the positioning board, a driving element, two guiding rails mounted on the case, and a conveyor belt located between the two guiding rails; the conveyor belt rotates about two rollers one of which is rotated by the driving element, the sliding board is slidably attached to the conveyor belt and capable of sliding along the two guiding rails; the positioning board is attached to the sliding block.
